(19) United States
(12) Patent Application Publication
(10) Pub. No.: US 2006/0171266 A1
(43) Pub. Date: Aug. 3, 2006

(54) Tilt adjustment apparatus and method

(75) Inventor: Ryusuke Noda, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/331,065

(22) Filed: Jan. 13, 2006

(30) Foreign Application Priority Data
Jan. 14, 2005 (JP) P2005-007489

(51) Int. Cl. G11B 7/00

(52) U.S. Cl. 369/44.32; 369/53.19

(57) ABSTRACT

For an unrecorded disk, the tilt amount where the amplitude of a tracking error signal is maximum is detected by changing the tilt amount of the optical pickup in a tracking OFF state at plural preset positions in the radial direction of the optical disk, or for a recorded disk, the tilt amount where the amplitude of the RF signal is maximum is detected by changing the tilt amount of the optical pickup in a tracking ON state at plural preset positions in the radial direction of the optical disk, and the tilt amount is corrected, based on the detected tilt amount at the recording/reproduction time of the optical disk. Also, if the difference between the maximum and minimum amplitudes of the tracking error signal and the RF signal is small, the tracking error signal and the RF signal are amplified to a predetermined signal level.

### BACKGROUND OF THE INVENTION

1. Field of the Invention

The present invention relates to a tilt adjustment apparatus and method for recording or reproducing the information data in or from an optical disk, and more particularly to a tilt adjustment apparatus and method for improving the approximation precision in tilt adjustment of an optical pickup in a disk unit.

2. Description of the Related Art

Generally, in recording the information data in a write-once optical disk such as a DVD-R (Digital Versatile Disc-Recordable) or a rewritable optical disk such as a DVD-RW (DVD-ReWritable), it is required to correct a radial tilt amount (hereinafter referred to as a tilt amount) of the optical pickup on the specifications. A correction method of the tilt amount for the optical pickup involves detecting the inclination of a laser beam of the optical pickup, employing a tilt sensor, and correcting the tilt amount of the optical pickup. However, there was a problem that if the tilt sensor was employed, the size of the optical pickup was increased, and the cost of the optical pickup was not reduced. Also, the tilt amount of the optical pickup may be adjusted by detecting a tracking error signal and an RF (Radio Frequency) signal with the optical pickup. However, when the signal level of the tracking error signal and the RF signal detected by the optical pickup is small, with a small difference between the maximum and minimum amplitudes of the tracking error signal and the RF signal, there was a problem that the optimal tilt amount of the optical pickup could not be detected because the detection precision of the tracking error signal and the RF signal was lower.

As a prior art, the tilt amount of the optical pickup was corrected to maximize the RF signal in the recorded area of the optical disk, and the tilt amount of the optical pickup was corrected to maximize the LPP (Land PrePit) signal in the unrecorded area of the optical disk (e.g., refer to JP-A-2004-95035).

Also, the tilt amount of the optical pickup was corrected by detecting the maximum and minimum values of an RF envelop signal in a rotational period of the optical disk, calculating a difference value between them, driving each divided area of a liquid crystal panel arranged on the optical axis of laser beam, changing a phase correction amount in a direction where the difference value is smaller, and giving a phase difference to a passing light of the optical pickup (e.g., refer to JP-A-11-273114).

However, in the former as described in the prior art, though the tilt amount of the optical pickup could be corrected to maximize the RF signal in the recorded area of the optical disk, and the tilt amount of the optical pickup was corrected to maximize the LPP signal in the unrecorded area of the optical disk, an offset amount between the tilt amount of the optical pickup to maximize the RF signal detected from the recorded area of the optical disk and the tilt amount of the optical pickup to maximize the LPP signal detected from the unrecorded area of the optical disk was measured to correct the tilt amount of the optical pickup in the recorded area and the unrecorded area of the optical disk, and the tilt amount of the optical pickup was corrected to maximize the RF signal in the unrecorded area based on the offset amount, whereby the above problem was not solved.

Also, in the latter, though the tilt amount of the optical pickup could be corrected by detecting the maximum and minimum values of the RF envelope signal in the rotation period of the optical disk to obtain a difference value between them, driving each divided area of the liquid crystal panel arranged on the optical axis of laser beam to change the phase correction amount in a direction where the difference value is smaller, and giving a phase difference to the passing light of the optical pickup, the tilt amount of the optical pickup was corrected by driving each divided area of the liquid crystal panel to change the phase difference in the passing light of laser beam radiated to the optical disk, whereby the above problem was not solved.

This invention has been achieved in the light of the above-mentioned problems associated with the prior art, and it is an object of the invention to provide a tilt adjustment apparatus that can improve the approximation precision of tilt adjustment for an optical pickup even if the signal level of a tracking error signal and an RF signal is small, with a small difference between the maximum and minimum amplitudes of the tracking error signal and the RF signal.

### SUMMARY OF THE INVENTION

In order to accomplish the above object, the present invention provides a tilt adjustment apparatus for adjusting the tilt amount of an optical pickup in a disk unit that records or reproduces the information data in or from an optical disk, characterized by including read-out means for reading an RF signal from the optical disk, discrimination means for discriminating whether or not the optical disk is unrecorded disk based on the presence or absence of the RF signal read by the read-out means, detection means for detecting the tilt amount where the amplitude of a tracking error signal is maximum by changing the tilt amount of the optical pickup in a tracking OFF state at plural preset positions in the radial direction of the optical disk, and if the difference between the maximum and minimum amplitudes of the tracking error signal is small, detecting the tilt amount where the amplitude of the tracking error signal is maximum by amplifying the tracking error signal to a predetermined signal level, when the discrimination means discriminates that the optical disk is unrecorded disk, and detecting the tilt amount where the amplitude of the RF signal is maximum by changing the tilt amount of the optical pickup in a tracking ON state at plural preset positions in the radial direction of the optical disk, and if the difference between the maximum and minimum amplitudes of the RF signal is small, detecting the tilt amount where the amplitude of the RF signal is maximum by amplifying the RF signal to a predetermined signal level, when the discrimination means discriminates that the optical disk is not unrecorded disk, and correction means for correcting the tilt amount of the optical pickup, based on the tilt amount detected by the detection means at the recording/reproduction time of the optical disk.

The detection means may detect the tilt amount where the amplitude of the tracking error signal is maximum by changing the tilt amount of the optical pickup in the tracking OFF state at least between the inner circumferential position and the outer circumferential position in the radial direction of the optical disk, when the discrimination means discriminates that the optical disk is unrecorded disk, and detects the tilt amount where the amplitude of the RF signal is maximum by changing the tilt amount of the optical pickup in the tracking ON state at least between the inner circumferential position and the outer circumferential position in the radial direction of the optical disk, when the discrimination means discriminates that the optical disk is not unrecorded disk.

The correction means may correct the tilt amount of the optical pickup, based on the calculated tilt amount, by linearly approximating the tilt amount detected by the detection means and calculating the tilt amount of the optical pickup at the current position in the radial direction of the optical disk.

With the tilt adjustment apparatus according to a first aspect of the present invention, including read-out means for reading an RF signal from the optical disk, discrimination means for discriminating whether or not the optical disk is unrecorded disk based on the presence or absence of the RF signal read by the read-out means, detection means for detecting the tilt amount where the amplitude of a tracking error signal is maximum by changing the tilt amount of the optical pickup in a tracking OFF state at least between an inner circumferential position and an outer circumferential position in the radial direction of the optical disk, and if the difference between the maximum and minimum amplitudes of the tracking error signal is small, detecting the tilt amount where the amplitude of the tracking error signal is maximum by amplifying the tracking error signal to a predetermined signal level, when the discrimination means discriminates that the optical disk is unrecorded disk, and detecting the tilt amount where the amplitude of the RF signal is maximum by changing the tilt amount of the optical pickup in a tracking ON state at least between the inner circumferential position and the outer circumferential position in the radial direction of the optical disk, and if the difference between the maximum and minimum amplitudes of the RF signal is small, detecting the tilt amount where the amplitude of the RF signal is maximum by amplifying the RF signal to a predetermined signal level, when the discrimination means discriminates that the optical disk is not unrecorded disk, and correction means for correcting the tilt amount of the optical pickup, based on the calculated tilt amount, by linearly approximating the detected tilt amount and calculating the tilt amount of the optical pickup at the current position in the radial direction of the optical disk at the recording/reproduction time of the optical disk, there is the effect that even if the signal level of the tracking error signal and the RF signal is small, with a small difference between the maximum and minimum values of the tracking error signal and the RF signal, the approximation precision of tilt adjustment for the optical pickup can be improved.

With the tilt adjustment apparatus according to a second aspect of the present invention, including read-out means for reading an RF signal from the optical disk, discrimination means for discriminating whether or not the optical disk is unrecorded disk based on the presence or absence of the RF signal read by the read-out means, detection means for detecting the tilt amount where the amplitude of a tracking error signal is maximum by changing the tilt amount of the optical pickup in a tracking OFF state at plural preset positions in the radial direction of the optical disk, and if the difference between the maximum and minimum amplitudes of the tracking error signal is small, detecting the tilt amount where the amplitude of the tracking error signal is maximum by amplifying the tracking error signal to a predetermined signal level, when the discrimination means discriminates that the optical disk is unrecorded disk, and detecting the tilt amount where the amplitude of the RF signal is maximum by changing the tilt amount of the optical pickup in a tracking ON state at plural preset positions in the radial direction of the optical disk, and if the difference between the maximum and minimum amplitudes of the RF signal is small, detecting the tilt amount where the amplitude of the RF signal is maximum by amplifying the RF signal to a predetermined signal level, when the discrimination means discriminates that the optical disk is not unrecorded disk, and correction means for correcting the tilt amount of the optical pickup, based on the detected tilt amount at the recording/reproduction time of the optical disk, there is the effect that even if the signal level of the tracking error signal and the RF signal is small, with a small difference between the maximum and minimum values of the tracking error signal and the RF signal, the approximation precision of tilt adjustment for the optical pickup can be improved.

With the tilt adjustment apparatus according to a third aspect of the present invention, since the detection means detects the tilt amount where the amplitude of the tracking error signal is maximum by changing the tilt amount of the optical pickup in the tracking OFF state at least between the inner circumferential position and the outer circumferential position in the radial direction of the optical disk, when it is discriminated that the optical disk is unrecorded disk, and detects the tilt amount where the amplitude of the RF signal is maximum by changing the tilt amount of the optical pickup in the tracking ON state at least between the inner circumferential position and the outer circumferential position in the radial direction of the optical disk, when it is discriminated that the optical disk is not unrecorded disk, there is the effect that the detection time of the tilt amount of the optical pickup can be shortened.

With the tilt adjustment apparatus according to a fourth aspect of the present invention, since the correction means corrects the tilt amount of the optical pickup, based on the calculated tilt amount, by linearly approximating the detected tilt amount and calculating the tilt amount of the optical pickup at the current position in the radial direction of the optical disk, there is the effect that the tilt amount of the optical pickup at the current position in the radial direction can be easily calculated based on the detected tilt amount.

With the tilt adjustment method according to a fifth aspect of the present invention, including a step of reading an RF signal from the optical disk, a step of discriminating whether or not the optical disk is unrecorded disk based on the presence or absence of the read RF signal, a step of detecting the tilt amount where the amplitude of a tracking error signal is maximum by changing the tilt amount of the optical pickup in a tracking OFF state at plural preset positions in the radial direction of the optical disk, and if the difference between the maximum and minimum amplitudes of the tracking error signal is small, detecting the tilt amount where the amplitude of the tracking error signal is maximum by amplifying the tracking error signal to a predetermined signal level, when it is discriminated that the optical disk is unrecorded disk, a step of detecting the tilt amount where the amplitude of the RF signal is maximum by changing the tilt amount of the optical pickup in a tracking ON state at plural preset positions in the radial direction of the optical disk, and if the difference between the maximum and minimum amplitudes of the RF signal is small, detecting the tilt amount where the amplitude of the RF signal is maximum by amplifying the RF signal to a predetermined signal level, when it is discriminated that the optical disk is not unrecorded disk, and a step of correcting the tilt amount of the optical pickup, based on the calculated tilt amount, by linearly approximating the detected tilt amount and calculating the tilt amount of the optical pickup at the current position in the radial direction of the optical disk at the recording/reproduction time of the optical disk, there is the effect that even if the signal level of the tracking error signal and the RF signal is small, with a small difference between the maximum and minimum values of the tracking error signal and the RF signal, the approximation precision of tilt adjustment for the optical pickup can be improved.

### BRIEF DESCRIPTION OF THE DRAWINGS

FIG. 1 is a block diagram showing the configuration of a tilt adjustment apparatus according to one embodiment of the present invention;

FIGS. 2A to 2C are explanatory views showing the operation of the tilt adjustment apparatus according to one embodiment of the invention;

FIG. 3 is a flowchart showing a detection operation of the tilt amount of the optical pickup in the tilt adjustment apparatus according to one embodiment of the invention; and

FIG. 4 is a flowchart showing a correction operation of the tilt amount of the optical pickup in the tilt adjustment apparatus according to one embodiment of the invention.

### DETAILED DESCRIPTION OF THE INVENTION

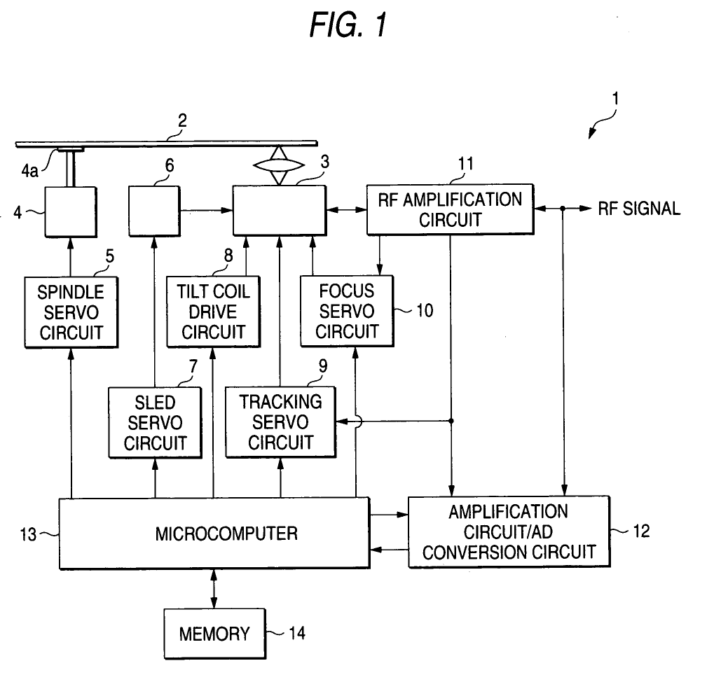

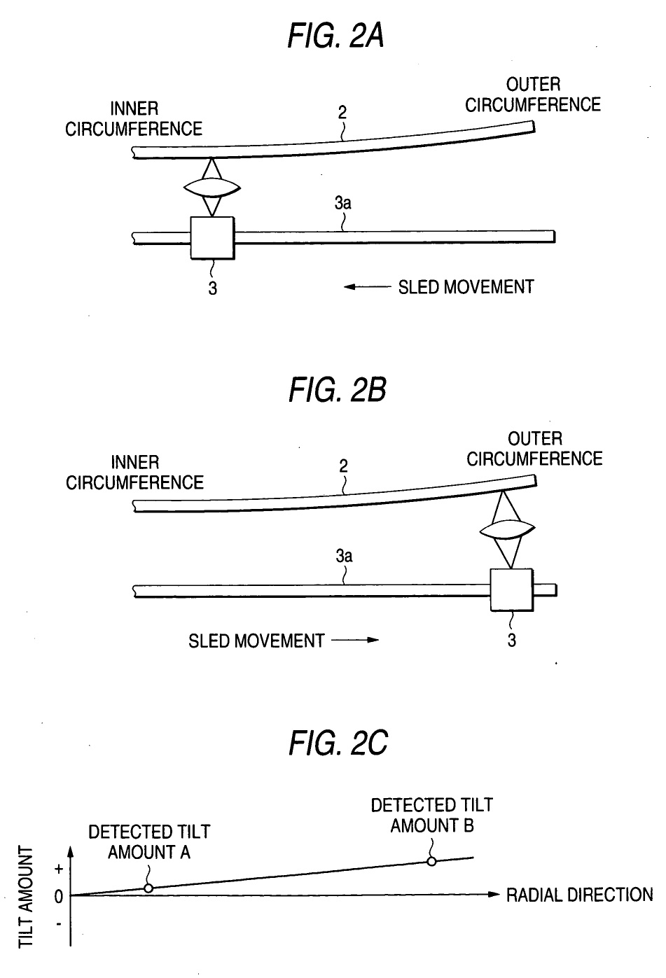

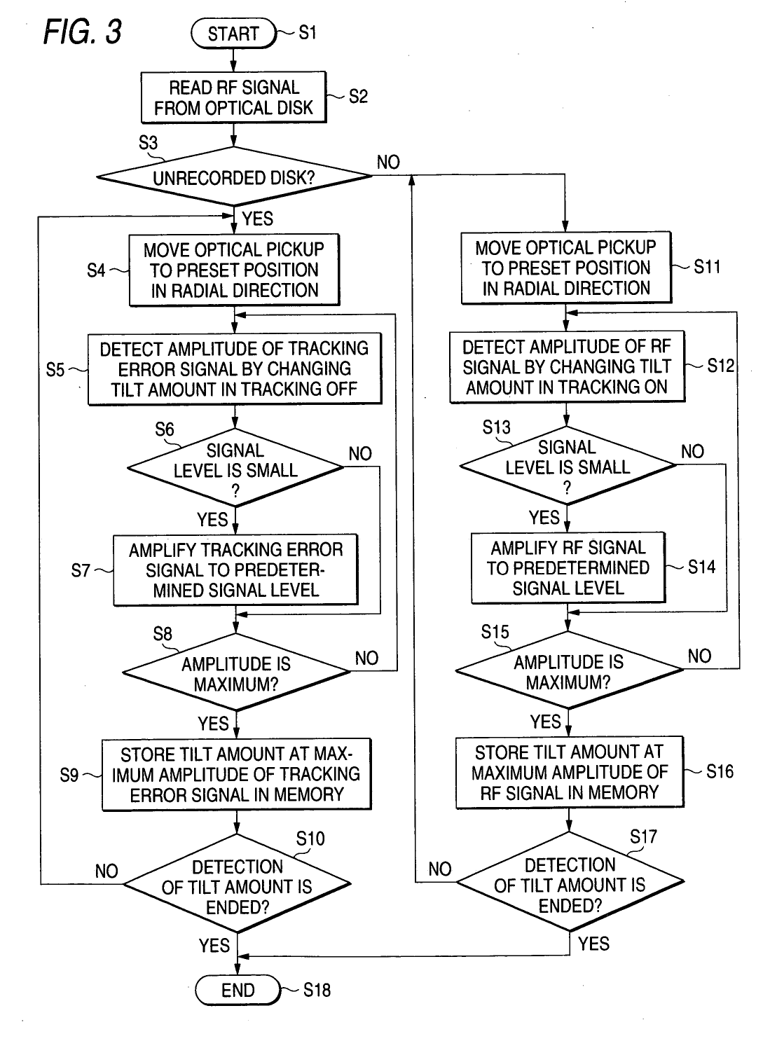

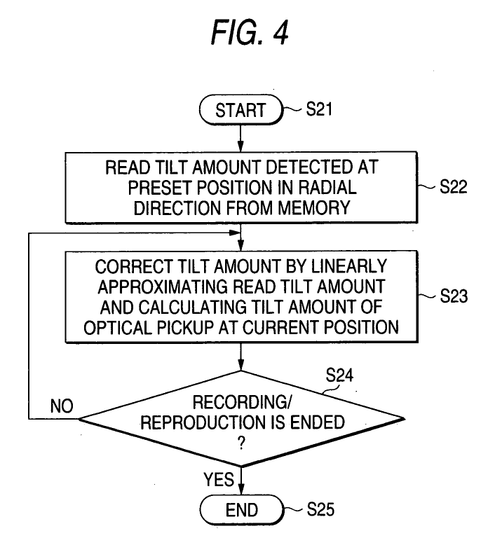

The best mode for carrying out the present invention will be described below in detail with reference to the accompanying drawings. FIG. 1 is a block diagram showing the configuration of a tilt adjustment apparatus according to one embodiment of the invention. FIGS. 2A to 2C are explanatory views showing the operation of the tilt adjustment apparatus according to one embodiment of the invention. FIG. 3 is a flowchart showing a detection operation of the tilt amount of an optical pickup for the tilt adjustment apparatus according to one embodiment of the invention. FIG. 4 is a flowchart showing a correction operation of the tilt amount of the optical pickup for the tilt adjustment apparatus according to one embodiment of the invention.

Referring to the block diagram of FIG. 1, first of all, the configuration of the tilt adjustment apparatus according to one embodiment of the invention will be described below.

The tilt adjustment apparatus 1 for adjusting the tilt amount of the optical pickup for a disk unit includes an optical pickup 3 for recording the information data in an optical disk 2 by radiating a laser beam to the optical disk 2, and reading the information data recorded in the optical disk by radiating a laser beam to the optical disk 2 and detecting its reflected light, a spindle motor 4 for rotating the optical disk 2 mounted on a turntable 4a, a spindle servo circuit 5 for making the servo control for the rotation speed of the spindle motor 4, a sled motor 6 for sledding the optical disk 3 in the radial direction of the optical disk 2, a sled servo circuit 7 for making the servo control for the rotational direction and the rotation speed of the sled motor 6, a tilt coil drive circuit 8 for adjusting the tilt amount of the optical pickup by driving a tilt coil (not shown) of the optical pickup 3, a tracking servo circuit 9 for making the servo control for the tracking of the optical pickup 3, based on a tracking error signal detected by the optical pickup 3, a focus servo circuit 10 for making the servo control for the focusing of the optical pickup 3, based on a focus error signal detected by the optical pickup 3, an RF amplification circuit 11 for amplifying the tracking error signal, the focus error signal, the RF signal and information data detected by the optical pickup 3 and amplifying the information data recorded in the optical disk, an amplification circuit/AD (Analog-Digital) conversion circuit 12 for amplifying the tracking signal and the RF signal amplified by the RF amplification circuit 11 to a predetermined signal level and converting the tracking error signal and the RF signal of analog signal into digital signal, if the difference between the maximum and minimum amplitudes of the tracking signal and the RF signal amplified by the RF amplification circuit 11 is small, a microcomputer 13 for controlling the whole system of the tilt adjustment apparatus 1 for adjusting the tilt amount of the optical pickup in the disk unit, and a memory 14 for storing the tilt amount of the optical pickup 3.

The operation of the tilt adjustment apparatus as constituted above will be described below.

If the optical disk 2 is mounted on the turntable 4a of the disk unit, the microcomputer 13 sends out a control signal to the spindle servo circuit 5 to drive the spindle motor 4 to rotate the optical disk 2, sends out a control signal to the sled servo circuit 7 to drive the sled motor 6 to sled the optical pickup 3 to a data recording area (not shown) of the optical disk 2, sends out a control signal to the tracking servo circuit 9 and the focus servo circuit 10 to make the servo control for the tracking and focusing of the optical pickup 3, and reads out an RF signal from the optical disk 2 with the optical pickup 3 to discriminate whether or not the optical disk 2 mounted on the turntable 4a of the disk unit is unrecorded disk.

If the RF signal is not read from the optical disk 2 mounted on the turntable 4a of the disk unit, the microcomputer 13 discriminates that the optical disk 2 mounted on the turntable 4a of the disk unit is unrecorded disk, and sends out a control signal to the sled servo circuit 7 to sled the optical pickup 3 to a preset first position in the radial direction of the optical disk 2 along a guide shaft 3a, for example, an inner circumferential position in the radial direction of the optical disk 2 (see FIG. 2A), sends out a control signal to the tracking servo circuit 9 to turn off the servo control for the tracking of the optical pickup 3 so that the amplitude of the tracking error signal detected by the optical pickup 3 may not be fixed, sends out a control signal to the tilt coil drive circuit 8 to change a drive voltage of the tilt coil (not shown) of the optical pickup 3 in a tracking off state and change the tilt amount of the optical pickup 3 to detect the amplitude of the tracking error signal in the amplification circuit/AD conversion circuit 12. When the signal level of the tracking error signal detected by the optical pickup 3 and amplified by the RF amplification circuit 11 is small, with a small difference between the maximum and minimum amplitudes of the tracking error signal, the microcomputer 13 sends out a control signal to the amplification circuit/AD conversion circuit 12 to amplify the tracking error signal amplified by the RF amplification circuit 11 to a predetermined signal level to improve the detection precision of the amplitude of the tracking error signal. And if the microcomputer 13 detects the tilt amount at which the amplitude of the tracking error signal is maximum by changing the drive voltage of the tilt coil (not shown) for the optical pickup 3, the tilt amount of the optical pickup 3 at which the amplitude of the tracking error signal is maximum is stored as the tilt amount A of the optical pickup 3 at the position in the radial direction of the optical disk 2 (see FIG. 2C) in the memory 14.

If the tilt amount of the optical pickup 3 at the inner circumferential position in the radial direction of the optical disk 2 is detected, the microcomputer 13 sends out a control signal to the sled servo circuit 7 to drive the sled motor 6 to sled the optical pickup 3 along the guide shaft 3a to a preset second position in the radial direction of the optical disk 2, for example, an outer circumferential position in the radial direction of the optical disk 2 (see FIG. 2B), whereby the tilt amount B of the optical pickup 3 at which the amplitude of the tracking error signal in the tracking off state is maximum (see FIG. 2C) is detected and stored in the memory 14 in the same way as above.

Also, if the RF signal is read from the optical disk 2 mounted on the turntable 4a of the disk unit, the microcomputer 13 discriminates that the optical disk 2 mounted on the turntable 4a of the disk unit is not unrecorded disk, and sends out a control signal to the sled servo circuit 7 to sled the optical pickup 3 to a preset first position in the radial direction of the optical disk 2 along the guide shaft 3a, for example, an inner circumferential position in the radial direction of the optical disk 2 (see FIG. 2A), sends out a control signal to the tracking servo circuit 9 to turn on the servo control for the tracking of the optical pickup 3, sends out a control signal to the tilt coil drive circuit 8 to change a drive voltage of the tilt coil (not shown) of the optical pickup 3 in a tracking on state and change the tilt amount of the optical pickup 3 to detect the amplitude of the RF signal in the amplification circuit/AD conversion circuit 12. When the signal level of the RF signal detected by the optical pickup 3 and amplified by the RF amplification circuit 11 is small, with a small difference between the maximum and minimum amplitudes of the RF signal, the microcomputer 13 sends out a control signal to the amplification circuit/AD conversion circuit 12 to amplify the RF signal amplified by the RF amplification circuit 11 to a predetermined signal level to improve the detection precision of the amplitude of the RF signal. And if the microcomputer 13 detects the tilt amount at which the amplitude of the RF signal is maximum by changing the drive voltage of the tilt coil (not shown) for the optical pickup 3, the tilt amount of the optical pickup 3 at which the amplitude of the RF signal is maximum is stored as the tilt amount A of the optical pickup 3 at the position in the radial direction of the optical disk 2 (see FIG. 2C) in the memory 14.

If the tilt amount of the optical pickup 3 at the inner circumferential position in the radial direction of the optical disk 2 is detected, the microcomputer 13 sends out a control signal to the sled servo circuit 7 to drive the sled motor 6 to sled the optical pickup 3 along the guide shaft 3a to a preset second position in the radial direction of the optical disk 2, for example, an outer circumferential position in the radial direction of the optical disk 2 (see FIG. 2B), whereby the tilt amount B of the optical pickup 3 at which the amplitude of the RF signal in the tracking off state is maximum (see FIG. 2C) is detected and stored in the memory 14 in the same way as above.

If the recording/reproduction of the optical disk 2 mounted on the turntable 4a of the disk unit is commanded, the microcomputer 13 reads the tilt amount A and the tilt amount B of the optical pickup 3 detected at the inner circumferential position and the outer circumferential position in the radial direction of the optical disk, which are stored in the memory 14, sends out a control signal to the spindle servo circuit 5 to drive the spindle motor 4 to rotate the optical disk 2, sends out a control signal to the sled servo circuit 7 to drive the sled motor 6 to sled the optical pickup 3 in the radial direction of the optical disk 2, sends out a control signal to the tracking servo circuit 9 and the focus servo circuit 10 to make the servo control for the tracking and focusing of the optical pickup 3, calculates the tilt amount of the optical pickup 3 at the current position in the radial direction of the optical disk 2 by linearly approximating the tilt amount A (see FIG. 2C) at the inner circumferential position in the radial direction of the optical disk 2 and the tilt amount B (see FIG. 2C) at the outer circumferential position in the radial direction of the optical disk 2, which are read from the memory 14, sends out a control signal to the tilt coil drive circuit 8 to correct the tilt amount of the optical pickup 3 based on the calculated tilt amount, and record or reproduce the information data in or from the optical disk 2.

Referring to a flowchart of FIG. 3, the detection operation of the tilt amount of the optical pickup in the tilt adjustment apparatus according to one embodiment of the invention will be described below.

If the optical pickup is mounted on the turntable of the disk unit, the procedure goes from step S1 to step S2, where the RF signal is read from the optical disk with the optical pickup, and goes to step S3.

At step S3, a determination whether or not the optical disk mounted on the turntable of the disk unit is unrecorded disk is made depending on whether or not the RF signal is read from the optical disk. If the optical disk mounted on the turntable of the disk unit is unrecorded disk, the procedure goes to step S4, or if the optical disk mounted on the turntable of the disk unit is not unrecorded disk, the procedure goes to step S11.

At step S4, the optical pickup is moved to the preset position in the radial direction of the optical disk, and the procedure goes to step S5.

At step S5, the tilt amount of the optical pickup in the tracking off state is changed to detect the amplitude of the tracking error signal, and the procedure goes to step S6.

At step S6, a determination is made whether or not the signal level of the detected tracking error signal is small. If the signal level of the detected tracking error signal is small, the procedure goes to step S7, or if the signal level of the detected tracking error signal is not small, the procedure goes to step S8. At step S7, the detected tracking error signal is amplified to a predetermined signal level, and the procedure goes to step S8.

At step S8, a determination is made whether or not the amplitude of the tracking error signal in changing the tilt amount of the optical pickup is maximized. If the amplitude of the tracking error signal is maximized, the procedure goes to step S9, or if the amplitude of the tracking error signal is not maximized, the procedure turns back to step S5 to repeat the steps from step S5.

At step S9, the tilt amount of the optical pickup at which the amplitude of the tracking error signal is maximum is stored as the tilt amount of the optical pickup at the position in the radial direction in the memory, and the procedure goes to step S10.

At step S10, a determination is made whether or not the detection of the tilt amount of the optical pickup at plural preset positions in the radial direction of the optical disk is ended. If the detection of the tilt amount of the optical pickup at plural preset positions in the radial direction of the optical disk is ended, the procedure goes to step S18, whereby the procedure is ended, or if the detection of the tilt amount of the optical pickup at plural preset positions in the radial direction of the optical disk is not ended, the procedure turns back to step S4 to repeat the steps from step S4.

At step S11, the optical pickup is moved to the preset position in the radial direction of the optical disk, and the procedure goes to step S12.

At step S12, the tilt amount of the optical pickup in the tracking on state is changed to detect the amplitude of the RF signal, and the procedure goes to step S13.

At step S13, a determination is made whether or not the signal level of the detected RF signal is small. If the signal level of the detected RF signal is small, the procedure goes to step S14, or if the signal level of the detected RF signal is not small, the procedure goes to step S15.

At step S14, the detected RF signal is amplified to a predetermined signal level, and the procedure goes to step S15.

At step S15, a determination is made whether or not the amplitude of the RF signal in changing the tilt amount of the optical pickup is maximized. If the amplitude of the RF signal is maximized, the procedure goes to step S16, or if the amplitude of the RF signal is not maximized, the procedure turns back to step S12 to repeat the steps from step S12.

At step S16, the tilt amount of the optical pickup at which the amplitude of the RF signal is maximized is stored as the tilt amount of the optical pickup at the position in the radial direction in the memory, and the procedure goes to step S17.

At step S17, a determination is made whether or not the detection of the tilt amount of the optical pickup at plural preset positions in the radial direction of the optical disk is ended. If the detection of the tilt amount of the optical pickup at plural preset positions in the radial direction of the optical disk is ended, the procedure goes to step S18, whereby the procedure is ended, or if the detection of the tilt amount of the optical pickup at plural preset positions in the radial direction of the optical disk is not ended, the procedure turns back to step S11 to repeat the steps from step S11.

Referring to a flowchart of FIG. 4, the correction operation of the tilt amount of the optical pickup for the tilt adjustment apparatus according to one embodiment of the invention will be described below.

If the recording/reproduction of the optical disk is commanded, the procedure goes from step S21 to step S22, where the detected tilt amount at the preset position in the radial direction of the optical disk stored in the memory is read, and the procedure goes to step S23.

At step S23, the tilt amount at the current position in the radial direction of the optical disk is calculated by linearly approximating the tilt amount read from the memory, to correct the tilt amount of the optical pickup based on the calculated tilt amount, and the procedure goes to step S24.

At step S24, a determination is made whether or not the recording/reproduction of the optical disk is ended. If the recording/reproduction of the optical disk is ended, the procedure goes to step S25, whereby the procedure is ended, or if the recording/reproduction of the optical disk is not ended, the procedure turns back to step S23 to repeat the steps from step S23.

Though the best mode for carrying out the present invention has been detailed above, the invention is not limited to the above embodiment, but it will be apparent to those skilled in the art that various variations or modifications may be made without departing from the scope or spirit of the invention.

What is claimed is:

1. A tilt adjustment apparatus for adjusting a tilt amount of an optical pickup in a disk unit that records or reproduces information data in or from an optical disk, comprising:
a read-out unit that reads an RF signal from the optical disk;
a discrimination unit that discriminates whether or not the optical disk is an unrecorded disk based on presence or absence of the RF signal read by the read-out unit;
a detection unit that detects the tilt amount where an amplitude of a tracking error signal is maximum by changing the tilt amount of the optical pickup in a tracking OFF state at least between an inner circumferential position and an outer circumferential position in a radial direction of the optical disk, and if a difference between maximum and minimum of the amplitudes of the tracking error signal is small, detecting a tilt amount where the amplitude of the tracking error signal is maximum by amplifying the tracking error signal to a predetermined signal level, when the discrimination unit discriminates that the optical disk is an unrecorded disk, and detecting the tilt amount where the amplitude of the RF signal is maximum by changing the tilt amount of the optical pickup in a tracking ON state at least between the inner circumferential position and the outer circumferential position in the radial direction of the optical disk, and if the difference between maximum and minimum of amplitudes of the RF signal is small, detecting a tilt amount where the amplitude of the RF signal is maximum by amplifying the RF signal to a predetermined signal level, when the discrimination unit discriminates that the optical disk is not an unrecorded disk; and
a correction unit that corrects the tilt amount of the optical pickup, based on a tilt amount calculated by linearly approximating the tilt amount detected by the detection unit and calculating a tilt amount of the optical pickup at a current position in the radial direction of the optical disk on recording/reproducing the optical disk.

2. A tilt adjustment apparatus for adjusting a tilt amount of an optical pickup in a disk unit that records or reproduces information data in or from an optical disk, comprising:
a read-out unit that reads an RF signal from the optical disk;
a discrimination unit that discriminates whether or not the optical disk is an unrecorded disk based on presence or absence of the RF signal read by the read-out unit;
a detection unit that detects the tilt amount where an amplitude of a tracking error signal is maximum by changing the tilt amount of the optical pickup in a tracking OFF state at a plurality of preset positions in a radial direction of the optical disk, and if difference between maximum and minimum of the amplitudes of the tracking error signal is small, detecting a tilt amount where the amplitude of the tracking error signal is maximum by amplifying the tracking error signal to a predetermined signal level, when the discrimination unit discriminates that the optical disk is an unrecorded disk, and detecting the tilt amount where the amplitude of the RF signal is maximum by changing the tilt amount of the optical pickup in a tracking ON state at the plurality of preset positions in the radial direction of the optical disk, and if the difference between maximum and minimum of amplitudes of the RF signal is small, detecting a tilt amount where the amplitude of the RF signal is maximum by amplifying the RF signal to a predetermined signal level, when the discrimination unit discriminates that the optical disk is not an unrecorded disk; and
a correction unit that corrects the tilt amount of the optical pickup, based on the tilt amount detected by the detection unit on recording/reproducing the optical disk.

3. The tilt adjustment apparatus according to claim 2, wherein
the detection unit detects the tilt amount where the amplitude of the tracking error signal is maximum by changing the tilt amount of the optical pickup in the tracking OFF state at least between an inner circumferential position and an outer circumferential position in the radial direction of the optical disk, when the discrimination unit discriminates that the optical disk is an unrecorded disk, and detects the tilt amount where the amplitude of the RF signal is maximum by changing the tilt amount of the optical pickup in the tracking ON state at least between the inner circumferential position and the outer circumferential position in the radial direction of the optical disk, when the discrimination unit discriminates that the optical disk is not an unrecorded disk.

4. The tilt adjustment apparatus according to claim 2, wherein
the correction unit corrects the tilt amount of the optical pickup, based on a tilt amount calculated by linearly approximating the tilt amount detected by the detection unit and calculating a tilt amount of the optical pickup at a current position in the radial direction of the optical disk.

5. A tilt adjustment method for adjusting a tilt amount of an optical pickup in a disk unit that records or reproduces information data in or from an optical disk, the method comprising:
a read-out step of reading an RF signal from the optical disk;
a discrimination step of discriminating whether or not the optical disk is an unrecorded disk based on presence or absence of the RF signal read by the read-out step;
a first detection step of detecting the tilt amount where an amplitude of a tracking error signal is maximum by changing the tilt amount of the optical pickup in a tracking OFF state at a plurality of preset positions in a radial direction of the optical disk, and if difference between maximum and minimum of the amplitudes of the tracking error signal is small, detecting a tilt amount where the amplitude of the tracking error signal is maximum by amplifying the tracking error signal to a predetermined signal level, when it is discriminated that the optical disk is an unrecorded disk;
a second detection step of detecting the tilt amount where an amplitude of the RF signal is maximum by changing the tilt amount of the optical pickup in a tracking ON state at a plurality of preset positions in the radial direction of the optical disk, and if difference between maximum and minimum of amplitudes of the RF signal is small, detecting a tilt amount where the amplitude of the RF signal is maximum by amplifying the RF signal to a predetermined signal level, when it is discriminated that the optical disk is not an unrecorded disk; and
a correction step of correcting the tilt amount of the optical pickup, based on a tilt amount calculated by linearly approximating the detected tilt amount and calculating a tilt amount of the optical pickup at a current position in the radial direction of the optical disk on recording/reproducing the optical disk.
